(19) United States
(12) Patent Application Publication
(10) Pub. No.: US 2005/0263103 A1
(43) Pub. Date: Dec. 1, 2005

(54) Double leash coupler

(76) Inventors: Willard Updyke, Waverly, NY (US); Barbara Updyke, Waverly, NY (US)

Correspondence Address: LITMAN LAW OFFICES, LTD, PO BOX 15035, CRYSTAL CITY STATION, ARLINGTON, VA, 22215, US

(21) Appl. No.: 11/128,343

(22) Filed: May 13, 2005

Related U.S. Application Data
(60) Provisional application No. 60/570,940, filed on May 14, 2004.

(51) Int. Cl. A01K 27/00

(52) U.S. Cl. 119/796

(57) ABSTRACT

The double leash coupler is a dog-restraining device adapted to restrain at least two dogs. The coupler includes a swivel that is connected to a wrist strap and at least two carabiners that are attached to the swivel. The swivel includes a first loop and a second loop joined together by a post. Both loops may either pivot about the post or rotate about the post. The carabiners are attached to the second loop. Either standard or retractable leashes are connected to the carabiners and are available for attachment to a typical dog collar.

### CROSS-REFERENCE TO RELATED APPLICATION

This application claims the benefit of U.S. Provisional Patent Application Ser. No. 60/570,940, filed May 14, 2004.

### BACKGROUND OF THE INVENTION

1. Field of the Invention

The present invention relates to animal tethers, and more particularly to leash couplings that allow control of multiple animals without tangling the leads.

2. Description of the Related Art

Animal lovers may have two or more domesticated animals, such as dogs. Dogs, especially, need to be walked on a daily basis. There are those who love the animals but have neither time nor inclination to take the ultimate responsibility for the dogs' daily needs. This situation has led to the rather new job of professional dog walkers. Either way, a single person must now leash and control more than one individual animal, each of which may easily be pulling and moving along the pathway at will and without regard for the leashes and its companions' movements. This is a situation that has continually led to tangled leashes and resulting control problems for the person involved. Further, there are now new types of leashes that wind up around a spring-loaded center, allowing the animals to go both near and far at will. These newer leash types do not fit older multiple-animal leash schemes. There is a need for some simple, quick and easy method and apparatus for preventing tangled leashes in multiple-animal walking circumstances, no matter what type of leash is being used.

Towards that end, U.S. Pat. No. 4,879,972, issued to Crowe et al., teaches a double-length of lead that is capable of forming long or short leashes, depending upon configuration chosen. Two dogs on a short leash prevent the leashes from becoming entangled. Hooking together the multiple short ones forms a long leash.

U.S. Pat. No. 5,724,921, issued to Bell, discloses a pulley system at the end of an elastic rope, which itself is attached to a standard leash. Designed for human jogging, the elastic smoothes out pet disruptions to the exerciser, while the pulley allows both human arms to hold a single pet independent of all movements of the other arm. U.S. Pat. No. 5,632,234, issued to Parker, shows a pulley to control two dogs. The pulley self-adjusts leash lengths to prevent entanglements.

U.S. Pat. No. 6,273,029, issued to Gish, teaches a device that utilizes snap hooks with swivels to prevent multiple leash tangles. The device uses a complicated series of swivels both at the user's hand and at the dogs' leashes.

None of the above inventions and patents, taken either singly or in combination, is seen to describe the instant invention as claimed. Thus, a double leash coupler solving the aforementioned problems is desired.

### SUMMARY OF THE INVENTION

The double leash coupler is a dog-restraining device adapted to restrain at least two dogs. The double leash coupler allows either standard or retractable leashes to be attached to the coupler. The coupler includes a swivel that is connected to a wrist strap and at least two carabiners that are attached to the swivel. The leashes are attached to the carabiner loops. The leashes, which are able to be connected to a dog collar, may be standard, fixed length leashes or may be retractable leashes, having a retracting mechanism that attaches to the carabiner loop.

The swivel includes a first loop and a second loop joined together by a post. The first loop may either pivot back and forth or rotate about the post in order to allow for greater movement. The second loop may additionally either pivot back and forth or rotate about the post. The carabiners are attached to the second loop.

These and other features of the present invention will become readily apparent upon further review of the following specification and drawings.

### BRIEF DESCRIPTION OF THE DRAWINGS

FIG. 1 is an environmental, perspective view of a double leash coupler according to the present invention.

FIG. 2 is a perspective view of the double leash coupler according to the present invention.

FIG. 3 is a perspective view of the double leash coupler according to the present invention with standard leashes attached.

FIG. 4 is a perspective view of the double leash coupler according to the present invention with retractable leashes attached.

Similar reference characters denote corresponding features consistently throughout the attached drawings.

### DETAILED DESCRIPTION OF THE PREFERRED EMBODIMENT

The present invention is a leash coupler that allows two dogs to be held on the same leash. The double leash coupler, designated generally as 10 in the drawings, accommodates retractable leashes, as well as regular, fixed length leashes.

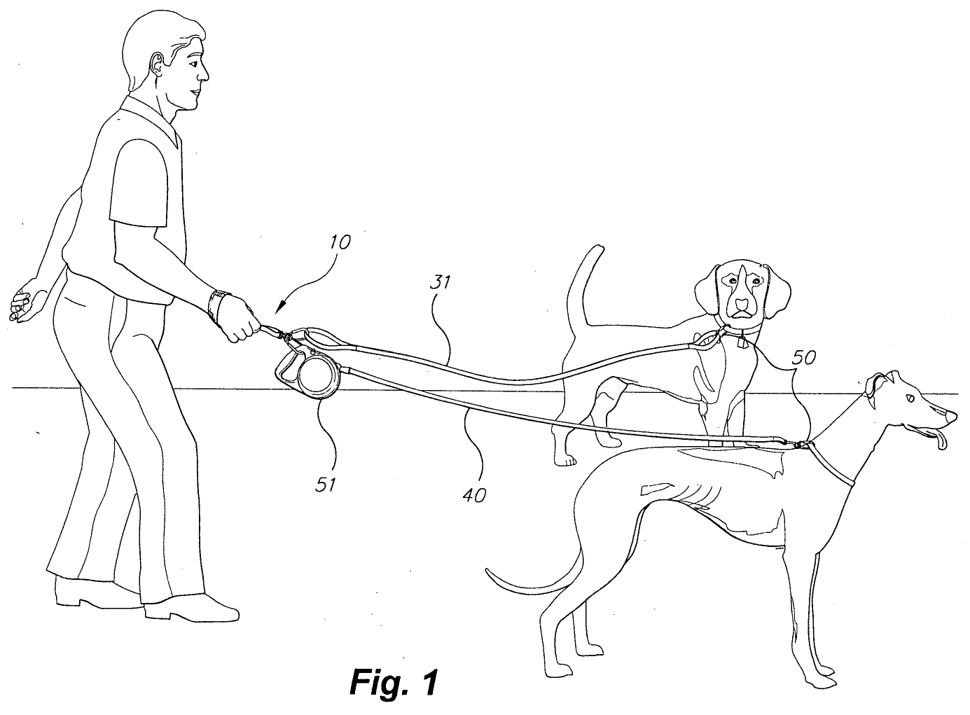

FIG. 1 shows an environmental view of the leash coupler. The double leash coupler 10 is adapted to restrain two dogs. The double leash coupler 10 may include one regular leash 31 attached to a standard dog collar attachment 50 on a first dog and one retractable leash 40 affixed to a standard dog collar attachment 50 on a second dog. The retractable leash 40 includes a retracting mechanism 51 that is integrally attached to the retractable leash 40.

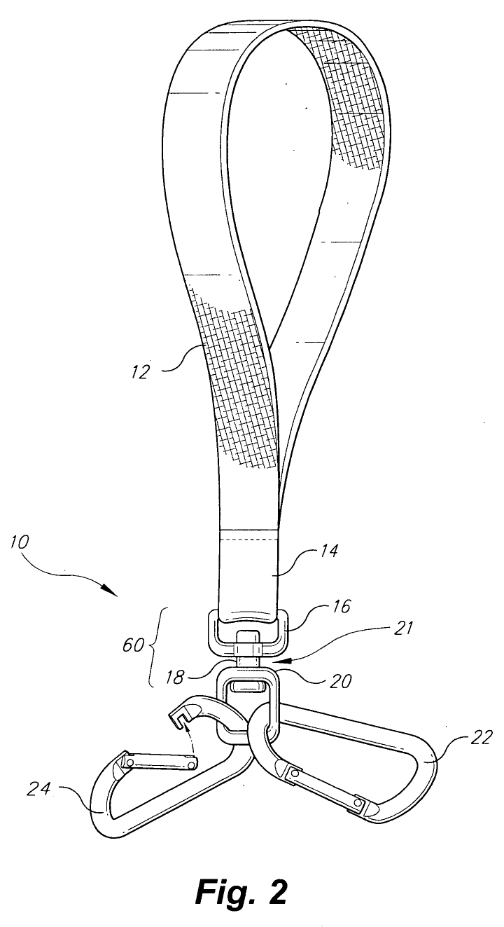

Turning now to FIG. 2, a perspective view of the double leash coupler 10 is shown. The double leash coupler 10 includes a first 22 and a second 24 carabiner that are both connected to a wrist strap 12. The wrist strap 12 has a closed end 14 that is attached to a swivel 60. The swivel 60 includes a first loop 16 and a second loop 20 joined together by a post 18. The first loop 16 may either pivot back and forth or rotate about the post 18 in order to allow for greater movement. The second loop 20 may also either pivot back and forth or rotate about the post 18.

A first 22 and second 24 carabiner are attached to the second loop 20. The carabiners 22 and 24 are typical metal loops having a spring-latched gate. Leashes 31 and 40 are able to be restrained to the carabiner loops. The gates of the carabiners 22 and 24 allow a user to connect and disconnect the leashes 30 and 41 from the carabiners 22 and 24 quickly and easily. The carabiners 22 and 24 are connected to the second loop 20 of the swivel 60 in such a manner as to allow unrestricted animal movement while maintaining untwisted leashes.

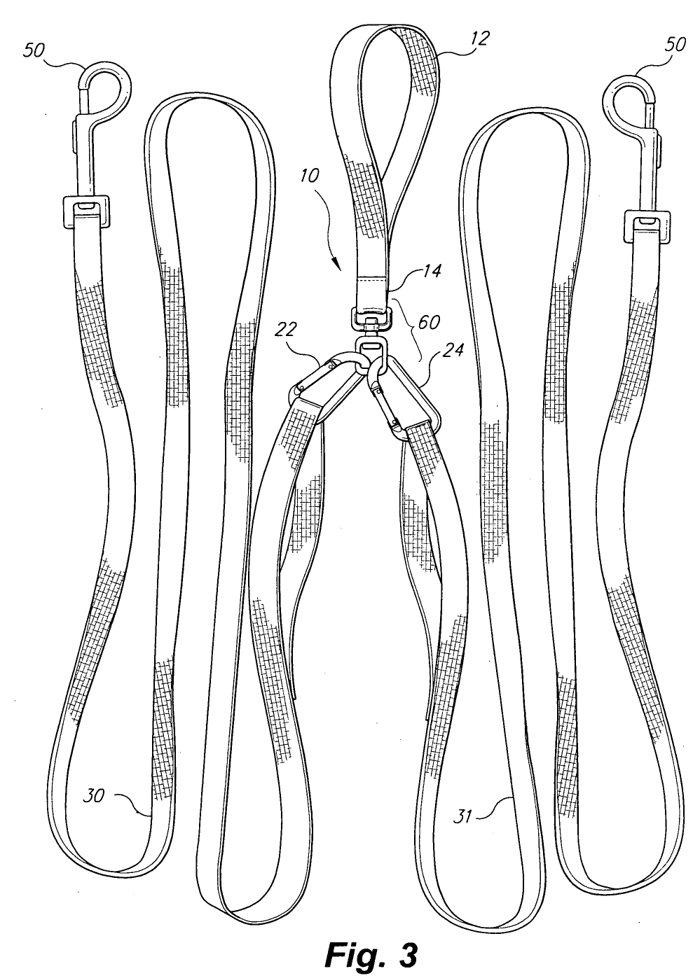

FIG. 3 shows a perspective view of the double leash coupler 10 having two leashes 30 and 31 attached. The first carabiner 22 has a first leash 30 hooked and restrained within the carabiner 22. The second carabiner 24 has a second leash 31 hooked and restrained within the carabiner 24. Each of the leashes 30 and 31 have a standard spring hook dog collar attachment 50 connected to the ends of the leashes 30 and 31.

The carabiners 22 and 24 displace the leashes 22 and 24 from each other, allowing multiple dogs to be able to move in different directions and cross leashes 30 and 31 without entangling the leashes 30 and 31 with each other. The carabiners 22 and 24 move relative to the position of the animal, causing the second loop 20 to rotate or pivot, depending on the direction in which the animal is going.

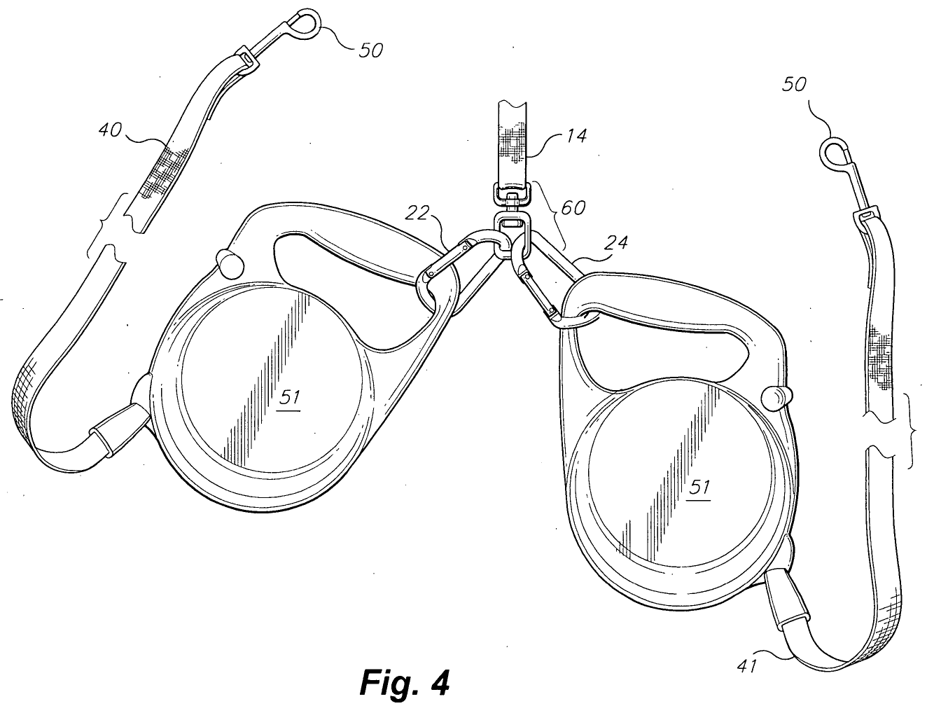

FIG. 4 shows the double leash coupler 10 with the addition of retractable leashes 40 and 41. Each leash 40 and 41 is attached to a carabiner 22 and 24, respectively. Each leash 40 and 41 includes a retracting mechanism 51. The retracting mechanism 51 allows a user to retract the leash 40 or 41 in order to restrain the dog held by the leash 40 or 41.

While FIGS. 3 and 4 show standard leashes 30 and 31 and retractable leashes 40 and 41, the double leash coupler 10 may use a combination of standard and retractable leashes that are each connected to a carabiner 22 and 24. Further, more than one leash may be optionally attached to a carabiner 22 or 24 at a time.

It is to be understood that the present invention is not limited to the embodiments described above, but encompasses any and all embodiments within the scope of the following claims.

1. A double leash coupler, comprising:
an elongated strap having opposed ends joined together to form a looped wrist strap having a closed end;
a first loop attached to the closed end of the wrist strap;
a second loop;
a post joining the second loop to the first loop; and
a plurality of carabiners, each carabiner being connected to the second loop and adapted for securing a dog leash to the wrist strap, whereby multiple dog leashes are independently joined to the wrist strap.

2. The double leash coupler according to claim 1, further comprising a plurality of leashes, at least one leash being attached to each of the carabiners.

3. The double leash coupler according to claim 2, wherein at least one of the leashes comprises a retractable dog leash.

4. The double leash coupler according to claim 1, wherein the first loop is pivotable about an axis transverse to the post.

5. The double leash coupler according to claim 1, wherein the second loop is pivotable about an axis transverse to the post.

6. The double leash coupler according to claim 1, wherein the first loop is rotatable about the post.

7. The double leash coupler according to claim 1, wherein the second loop is rotatable about the post.

8. A double leash coupler, comprising:
an elongated strap having opposed ends joined together to form a looped wrist strap having a closed end;
a first loop attached to the closed end of the wrist strap;
a second loop;
a post joining the second loop to the first loop, the first loop being rotatable around the post and pivotable about an axis normal to the post; and
a plurality of carabiners, each carabiner being connected to the second loop and adapted for securing a dog leash to the wrist strap, whereby multiple dog leashes are independently joined to the wrist strap.

9. The double leash coupler according to claim 8, further comprising a plurality of leashes, at least one leash being attached to each of the carabiners.

10. The double leash coupler according to claim 9, wherein at least one of the leashes comprises a retractable dog leash.

11. The double leash coupler according to claim 8, wherein the second loop is pivotable about an axis normal to the post.

12. The double leash coupler according to claim 8, wherein the second loop is rotatable about the post.

13. A double leash coupler, comprising:
an elongated strap having opposed ends joined together to form a looped wrist strap having a closed end;
a first loop attached to the closed end of the wrist strap;
a second loop;
a post joining the second loop to the first loop, both the first and the second loops being pivotable about an axis transverse to the post and rotatable about the post; and
a plurality of carabiners, each carabiner being connected to the second loop and adapted for securing a dog leash to the wrist strap, whereby multiple dog leashes are independently joined to the wrist strap.

14. The double leash coupler according to claim 13, further comprising a plurality of leashes, at least one leash being attached to each of the carabiners.

15. The double leash coupler according to claim 14, wherein at least one of the leashes comprises a retractable dog leash.
